(19) United States
(12) Patent Application Publication
(10) Pub. No.: US 2026/0088024 A1
(43) Pub. Date: Mar. 26, 2026

(54) CALLER INTENT RECOGNITION

(71) Applicant: Transaction Network Services, Inc., Reston, VA (US)

(72) Inventors: Sanjay Saini, Bengaluru (IN); Bryan Douglas Burns, Haymarket, VA (US)

(21) Appl. No.: 19/197,135

(22) Filed: May 2, 2025

(30) Foreign Application Priority Data
Sep. 24, 2024 (IN) 202421072143

(51) Int. Cl. G10L 15/18; G10L 13/027; G10L 15/183; G10L 15/30; H04M 3/436

(52) U.S. Cl. CPC G10L 15/1815; G10L 13/027; G10L 15/183; G10L 15/30; H04M 3/4365

(57) ABSTRACT

Disclosed are various embodiments for performing caller intent recognition. In one embodiment, a call is answered on a honeypot phone number previously used by a customer. The system communicates with a caller on the call using human-level synthetic speech generated based at least in part on a language model, where the human-level synthetic speech is generated to elicit information from the caller regarding an intent of the caller. The intent of the caller is determined based at least in part on the information from the caller provided in one or more responses of the caller to the human-level synthetic speech.

### BACKGROUND

The proliferation of telecommunication networks and the widespread use of mobile and landline phones have led to an increase in unwanted and unsolicited communications, commonly known as spam phone calls. These spam calls include automated robocalls, telemarketing solicitations, and fraudulent schemes targeting unsuspecting recipients. The impact of such calls is substantial, causing not only annoyance and inconvenience but also significant financial and privacy risks.

One of the primary challenges is the sheer volume of spam calls, often generated through automated systems capable of dialing vast numbers of phone lines in a short amount of time. These calls may originate domestically or internationally, making enforcement of regulations difficult. While some spam calls are merely disruptive, others are designed with malicious intent, aiming to deceive recipients into providing sensitive information or engaging in fraudulent transactions. Despite efforts by regulatory bodies, telecommunications companies, and technology developers to mitigate spam calls, the problem persists and continues to evolve.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIGS. 2-5 are flowcharts illustrating examples of functionality implemented as portions of a honeypot call answering service executed in a computing environment in the networked environment of FIG. 1 according to various embodiments of the present disclosure.

FIG. 6 is a schematic block diagram that provides one example illustration of a computing environment employed in the networked environment of FIG. 1 according to various embodiments of the present disclosure.

### DETAILED DESCRIPTION

The present disclosure generally relates to the use of honeypot phone numbers for the purpose of recognizing and classifying the caller's intent. Unsolicited and unwanted marketing and scam calls have increasingly become a problem for anyone with a phone line. While such calls may be illegal (e.g., under the United States Do Not Call Registry), bad actors may operate from international locations or may otherwise ignore the laws and regulations that prohibit such calls. Accordingly, it is important to have a screening system to either block such calls or to notify the recipient that the call may be spam or fraudulent.

Many smartphones rely on databases maintained by third-party companies or telecom providers to identify unwanted calls. These databases contain lists of phone numbers that have been reported as sources of spam or fraudulent activity. When a call is received, the phone checks the incoming number against these databases. If a match is found, the phone labels the call as “Spam,” “Telemarketer,” or “Potential Fraud. ” It is desirable to populate these databases automatically, without relying upon users reporting numbers, as users may be too busy to report a call as being a spam call. For example, if a user is driving a vehicle, he or she may not be able to easily undertake the actions necessary to report the call.

Various embodiments of the present disclosure introduce approaches that use honeypot phone numbers in conjunction with an automated caller intent recognition system. There is a constant turnover of phone numbers with communication service providers. For example, a customer may cancel their phone service without porting their phone number to another provider, causing their phone number to be released to a pool of available phone numbers. Immediately reassigning the phone number to another customer may cause the other customer to receive a number of calls, with legitimate or illegitimate intent, that were intended to be received by the previous customer. Rather than immediately reassigning the phone number to another customer, the released phone number may be assigned to a pool of honeypot phone numbers.

As will be described, a system is configured to automatically answer calls placed to any of the honeypot phone numbers. Artificial intelligence may be used to engage with the caller using human-level synthetic speech. The system may provide responses and ask questions in an effort to ascertain the caller's intent, which may be legitimate in trying to reach the previous customer, or illegitimate in trying to perpetuate a fraudulent scheme or market to the recipient in an illegal or unwanted way. Some callers may be quickly classified, while others may require the system to continue a conversation to ask additional questions or provide additional responses in order to determine the caller's intent beyond a threshold level of certainty. Once the caller's intent is recognized, the call may be ended, and the caller may be automatically added to the database of phone numbers associated with illegitimate or fraudulent activity. In addition, the system may gather essential metadata, such as the caller's identity, industry type, type of business, and the purpose of the call.

As one skilled in the art will appreciate in light of this disclosure, certain embodiments may be capable of achieving certain advantages, including some or all of the following: (1) improving the functioning of computer systems by automatically classifying incoming phone calls according to their intent; (2) improving the functioning of computer systems by automatically gathering metadata regarding unwanted or nuisance calls; (3) improving the functioning of computer systems by employing phone numbers released by customers to establish honeypot lines in a more efficient manner while ensuring that the honeypot lines are difficult for the callers to detect; and so forth. In the following discussion, a general description of the system and its components is provided, followed by a discussion of the operation of the same.

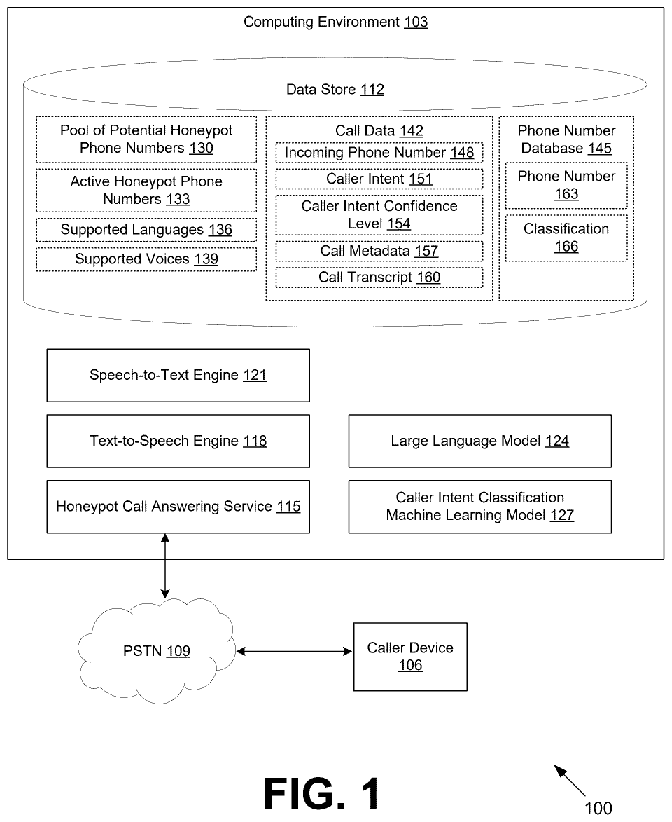

With reference to FIG. 1, shown is a networked environment 100 according to various embodiments. The networked environment 100 includes a computing environment 103 and a caller device 106 in communication via the public switched telephone network (PSTN) 109, which may include cellular telephone lines, land lines, voice over Internet Protocol lines, and so on. The PSTN 109 is the traditional circuit-switched network used globally for voice communication. The PSTN 109 comprises various interconnected networks operated by telephone companies, utilizing copper wires, fiber optics, switches, and other infrastructure. The PSTN 109 was originally designed for analog voice transmission but has evolved to support digital communication.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include a honeypot call answering service 115, a text-to-speech engine 118, a speech-to-text engine 121, a large language model (LLM) 124, a caller intent classification machine learning (ML) model 127, and other applications, services, processes, systems, engines, or functionality not discussed in detail herein. The honeypot call answering service 115 is executed to answer calls on designated honeypot phone lines and engage with the caller to determine the caller's intent. The honeypot call answering service 115, as needed, may carry on a conversation with the caller using generative artificial intelligence (AI) and the LLM 124, to elicit information from the caller that can be used to classify the caller's intent. For example, a call may be classified as legitimate, unwanted, or malicious. Once the honeypot call answering service 115 has sufficient confidence that the determined intent is accurate, the honeypot call answering service 115 may end the call.

The speech-to-text engine 121 is used to convert the caller's voice into text to be provided to the LLM 124. The speech-to-text engine 121 may be capable of transcribing many different types of voices speaking in various languages. Conversely, the text-to-speech engine 118 is executed to generate synthesized speech from text generated by the LLM 124. The text-to-speech engine 118 may generate speech in various voices, including male voices, female voices, old voices, young voices, voices with different regional accents, and so on.

The LLM 124 is a language model based upon generative artificial intelligence. The LLM 124 may be a general-purpose language model that is customized via prompt engineering for the specific purpose of engaging a caller in a conversation to obtain information from the caller that is useful in classifying the caller's intent. The prompt engineering process may include requesting that the LLM 124 not ask certain information (e.g., not ask for the caller's employee identification) that would likely offend the caller or seem unusual in a conversation.

The caller intent classification ML model 127 is executed to assign a caller intent classification to a given call based upon the information provided by the caller and potentially other metadata about the call. The caller intent classification ML model 127 may make its determination with a certain confidence level, where the confidence level may increase as the conversation progresses and more information from the caller is obtained. The caller intent classification ML model 127 may be trained based at least in part on assigning classifications to calls originating from phone numbers of known intent. For example, a transcript of a call from a phone number known to be associated with fraud may be used to train the caller intent classification ML model 127 to recognize fraud from the transcript. In this supervised learning process, accuracy may increase over time. In some cases, a rule set may be manually configured with rules for classifying caller intents. For example, a rule set may manually specify that a caller mentioning a “cash card” is associated with fraudulent intent. Such rules may be associated with weights in calculating the confidence level of the determination.

The data stored in the data store 112 includes, for example, a pool of potential honeypot phone numbers 130, active honeypot phone numbers 133, one or more supported languages 136, one or more supported voices 139, call data 142, a phone number database 145, and potentially other data. The pool of potential honeypot phone numbers 130 includes potentially thousands of phone numbers that were previously assigned to customers but have been released for reuse. Rather than immediately reusing such numbers, the phone numbers are added to the pool of potential honeypot phone numbers 130. This automated approach utilizing recently released phone numbers ensures a continuously replenished source of phone numbers. Consequently, this automated approach allows for a more efficient selection of phone numbers for honeypot lines (for example, as compared with a manual selection of available phone numbers), while also ensuring that the phone numbers are not easily detected as honeypot lines by the callers. If the callers detect a phone number as being a honeypot line, the callers may refrain from calling that number again. Moreover, the callers may potentially share that identification of the honeypot line with other callers, thereby limiting the usefulness of the honeypot line in gathering information. From the pool of potential honeypot phone numbers 130, a subset of the pool may be used as active honeypot phone numbers 133. The active honeypot phone numbers 133 are those which are active in the PSTN 109 and will be answered by the honeypot call answering service 115. The active honeypot phone numbers 133 may be randomly selected from the pool of potential honeypot phone numbers 130 and rotated after a period of time, which also helps avoid detection of the honeypot lines by the callers.

The supported languages 136 correspond to the languages that are understood by the LLM 124, the speech-to-text engine 121, and the text-to-speech engine 118. For example, the supported languages 136 may include English, Spanish, French, German, and so on. The supported voices 139 are the voices that can be synthesized by the text-to-speech engine 118. For example, the supported voices 139 may include male voices, female voices, young voices, old voices, voices with regional accents (e.g., Southern American English, New York English, etc.), and so on.

The call data 142 includes data regarding the calls that have been answered by the honeypot call answering service 115. The call data 142 may include, for example, an incoming phone number 148, a caller intent 151, a caller intent confidence level 154, call metadata 157, a call transcript 160, and/or other data. The incoming phone number 148 may correspond to the phone number that originated the call. In some cases, the incoming phone number 148 may be spoofed or masked (e.g., private). In one embodiment, the incoming phone number 148 may be used to select a voice with a regional accent or language corresponding to the geographic area associated with the incoming phone number 148.

The caller intent 151 is the intent of the caller that is determined through analysis of the conversation and/or other metadata by the caller intent classification ML model 127. In one embodiment, the caller intent 151 may be on a numerical scale from −5 (fraudulent or malicious intent) to +5 (legitimate personal call). On the scale, values in-between may include unwanted sales calls, legitimate sales calls from a preexisting relationship, or legitimate robocalls such as those signed up for by the customer. The caller intent 151 may be determined with reference to a caller intent confidence level 154. In one embodiment, the confidence level may range in values from 0 (least confident) to 100 (most confident). As the call progresses, the caller intent confidence level 154 should increase. Once a designated threshold confidence level is reached, the call may be disconnected.

The call metadata 157 may include information about the call including call time, whether the call appears to be prerecorded or generated by a text-to-speech engine 118, caller identification, information about the caller's identity, keywords or phrases used in the call, and so on. The call transcript 160 may include a transcript of the conversation represented in the call, which may be used in further analysis. For example, the call transcript 160 may be used to train the caller intent classification ML model 127.

The phone number database 145 associates phone numbers 163 with classifications 166. The classifications 166 may be assigned based at least in part on the caller intents 151 associated with one or more calls originating from the phone number 163. For example, if the phone number 163 repeatedly originates fraudulent calls, the classification 166 assigned to the phone number 163 may be that of a fraudulent caller. These classifications 166 may be used by communication service providers and others to provide call filtering or screening services to customers. In one embodiment, the classifications 166 may be provided to a smartphone via an application programming interface (API) so that the smartphone can render a warning, avoid ringing, or ignore the call.

The caller device 106 may correspond to a telephone, such as a smartphone or traditional telephone device, or the caller device 106 may correspond to an automated system implemented on a computing device such as a server. In some examples, a live person directly utilizes the caller device 106 to place a call. In other examples, the caller device 106 may include a robo-dialer that dials random phone numbers or phone numbers from a list of numbers. The caller device 106 may connect a live agent to the call once it is answered. In some cases, the caller device 106 may be driven by generative AI or another preconfigured model to generate speech.

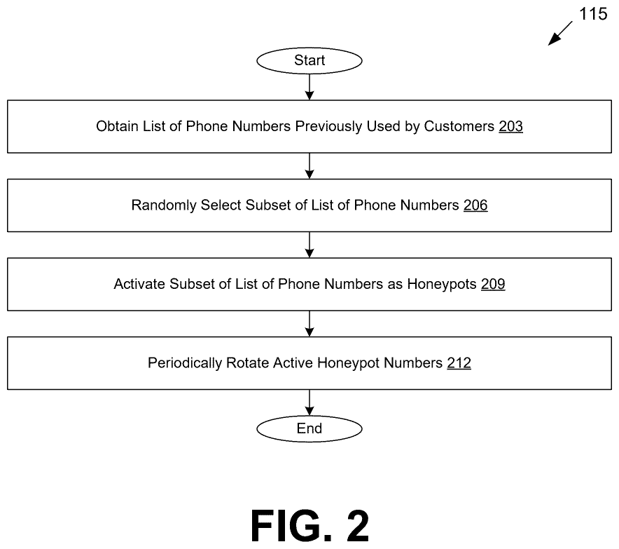

Referring next to FIG. 2, shown is a flowchart that provides one example of the operation of a portion of the honeypot call answering service 115 according to various embodiments. It is understood that the flowchart of FIG. 2 provides merely an example of the many different types of functional arrangements that may be employed to implement the operation of the portion of the honeypot call answering service 115 as described herein. As an alternative, the flowchart of FIG. 2 may be viewed as depicting an example of elements of a method implemented in the computing environment 103 (FIG. 1) according to one or more embodiments.

Beginning with box 203, the honeypot call answering service 115 obtains a list of phone numbers previously used by customers. These may be phone numbers released within a certain time frame to the communication service provider. Rather than reassigning these phone numbers immediately to new customers, they are instead added to the pool of potential honeypot phone numbers 130 for potential use as honeypot phone numbers.

In box 206, the honeypot call answering service 115 randomly selects a subset of the list of phone numbers to be used as honeypot phone numbers. For example, within a pool of 50,000 phone numbers, the honeypot call answering service 115 may select 5,000 to be used as active honeypot phone numbers 133. In box 209, the honeypot call answering service 115 actives the subset of the list of phone numbers as the active honeypot phone numbers 133. This means that the PSTN 109 is configured to route calls to the active honeypot phone numbers 133 to the honeypot call answering service 115 rather than to announce that the phone number has been disconnected.

In box 212, the honeypot call answering service 115 may periodically rotate the active honeypot phone numbers 133. For example, the honeypot call answering service 115 may randomly select a different 5,000 phone numbers from the pool of potential honeypot phone numbers 130. The previously used honeypot phone numbers may be deactivated and returned to the pool, while the newly selected subset of phone numbers may be activated as active honeypot phone numbers 133. Thereafter, the portion of the honeypot call answering service 115 ends.

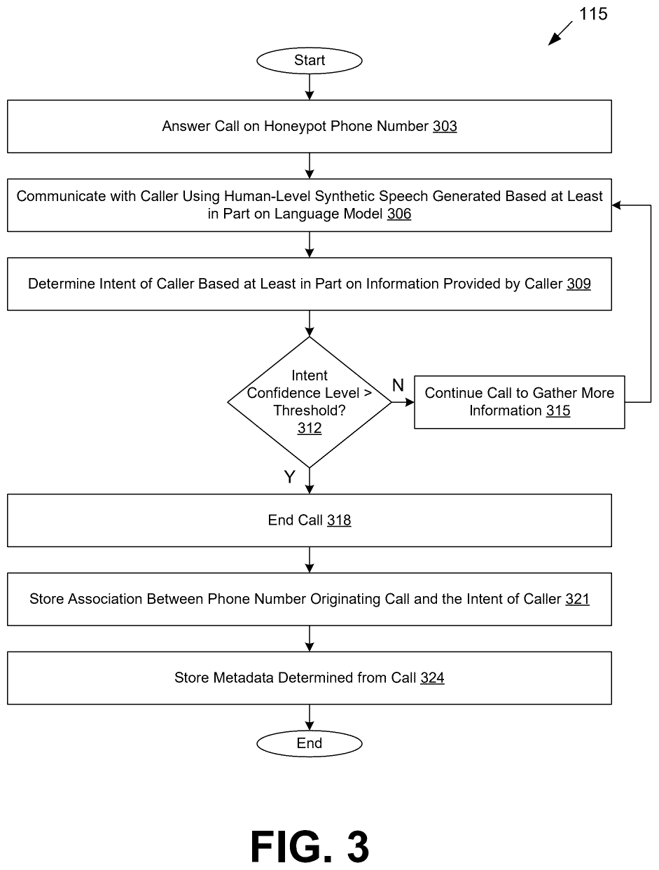

Turning now to FIG. 3, shown is a flowchart that provides one example of the operation of another portion of the honeypot call answering service 115 according to various embodiments. It is understood that the flowchart of FIG. 3 provides merely an example of the many different types of functional arrangements that may be employed to implement the operation of the portion of the honeypot call answering service 115 as described herein. As an alternative, the flowchart of FIG. 3 may be viewed as depicting an example of elements of a method implemented in the computing environment 103 (FIG. 1) according to one or more embodiments.

Beginning with box 303, the honeypot call answering service 115 answers a call on an active honeypot phone number 133. In so doing, the honeypot call answering service 115 may select a particular voice from the supported voices 139 and a particular language from the supported languages 136. For example, if the honeypot phone number is located in the Midwest United States, a voice corresponding to a midwestern English accent may be utilized. In answering the call, the honeypot call answering service 115 may play a greeting of recorded or synthesized speech (e.g., “hello,” “hi,” or so on). The cadence or speed of the voice may be adjusted in order to best communicate with the caller. For example, if the caller is determined to be an older person, the voice that is used may be slower.

In box 306, the honeypot call answering service 115 communicates with the caller using human-level synthetic speech generated based at least in part on a language model, such as an LLM 124. In some embodiments, the caller's speech is converted to text and then provided to the LLM 124, but in other embodiments, the recorded audio including the caller's speech may be directly provided to the LLM 124. The LLM 124 then generates a response to the caller's speech which is designed to elicit additional information from the caller to facilitate recognition of the caller's intent. In some embodiments, the LLM 124 may generate text which is then converted to synthesized speech, but in other embodiments, the LLM 124 may generate the synthesized speech directly as an audio file.

In box 309, the honeypot call answering service 115 determines an intent of the caller based at least in part on information provided by the caller during the course of the call as responses of the caller to the human-level synthetic speech as well as potentially other metadata about the call (e.g., time of call, geographic association of incoming phone number 148, and so on). In some embodiments, the intent is determined using a caller intent classification machine learning model 127, which is trained to recognize caller intent from call transcripts 160 and call metadata 157. In some embodiments, a manually curated rule set may be used to classify caller intent based, for example, upon keywords or phrases, such as immediate calls to action. The intent determination may be associated with a corresponding caller intent confidence level 154. As more information is gathered from the caller, the caller intent confidence level 154 may increase.

In box 312, the honeypot call answering service 115 determines whether the caller intent confidence level 154 meets or exceeds a threshold confidence level. For example, a confidence level of 85% meets a threshold of 80%. If the caller intent confidence level 154 does not meet or exceed the threshold, the honeypot call answering service 115 moves from box 312 to box 315 and continues the call to gather more information. For example, the honeypot call answering service 115 may continue the conversation with a question or a response to a question from the caller. The honeypot call answering service 115 returns to box 306 to continue the communication.

If the caller intent confidence level 154 is instead determined to meet or exceed the threshold value, the honeypot call answering service 115 moves from box 312 to box 318, where the honeypot call answering service 115 ends the call. For example, the honeypot call answering service 115 may cause human-level synthetic speech to be rendered on the call of “thank you, goodbye”and then hang up the call.

In box 321, the honeypot call answering service 115 stores an association between the incoming phone number 148 that originated the call and the caller intent 151. For example, the honeypot call answering service 115 may store the phone number 163 and an associated classification 166 in the phone number database 145. The phone number database 145 may then be used to screen, filter, or classify calls originating from the phone number 163. In box 324, the honeypot call answering service 115 may store call metadata 157 determined from the call in the data store 112. Thereafter, the operation of the portion of the honeypot call answering service 115 ends.

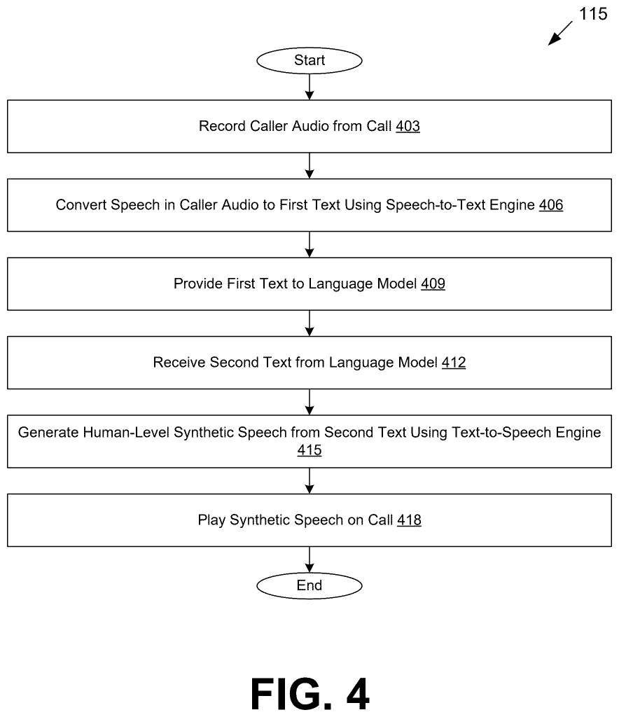

Moving on to FIG. 4, shown is a flowchart that provides one example of the operation of another portion of the honeypot call answering service 115 according to various embodiments. It is understood that the flowchart of FIG. 4 provides merely an example of the many different types of functional arrangements that may be employed to implement the operation of the portion of the honeypot call answering service 115 as described herein. As an alternative, the flowchart of FIG. 4 may be viewed as depicting an example of elements of a method implemented in the computing environment 103 (FIG. 1) according to one or more embodiments.

Beginning with box 403, the honeypot call answering service 115 records caller audio from a call. In box 406, the honeypot call answering service 115 converts the speech contained in the caller audio to first text using a speech-to-text engine 121. In box 409, the honeypot call answering service 115 provides the first text to the LLM 124. For example, the first text may include a question, e.g., “May I speak with John, please? ” In box 412, the honeypot call answering service 115 receives second text from the LLM 124. For example, the second text may include an answer, e.g., “Yes, this is John,” where the LLM 124 was able to answer the question based at least in part on information included in the first text, e.g., the name “John.” In some cases, the LLM 124 may utilize information gathered from multiple callers to better resemble a human response.

In box 415, the honeypot call answering service 115 generates human-level synthetic speech from the second text using a text-to-speech engine 118. For example, the speech may be embodied in an audio file. In box 418, the honeypot call answering service 115 plays the generated human-level synthetic speech on the call to the caller. Thereafter, the operation of the portion of the honeypot call answering service 115 ends.

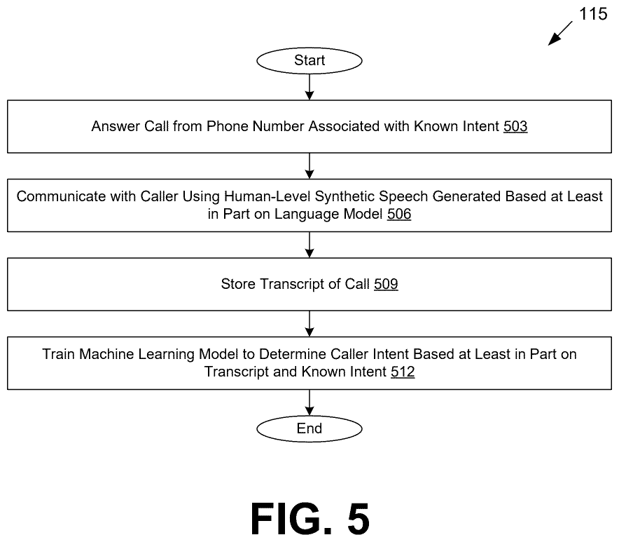

Continuing to FIG. 5, shown is a flowchart that provides one example of the operation of another portion of the honeypot call answering service 115 according to various embodiments. It is understood that the flowchart of FIG. 5 provides merely an example of the many different types of functional arrangements that may be employed to implement the operation of the portion of the honeypot call answering service 115 as described herein. As an alternative, the flowchart of FIG. 5 may be viewed as depicting an example of elements of a method implemented in the computing environment 103 (FIG. 1) according to one or more embodiments.

Beginning with box 503, the honeypot call answering service 115 answers a call from a phone number 163 that is associated with a known intent. For example, the call may be classified as a nuisance call, a fraudulent call, or a legitimate call. In box 506, the honeypot call answering service 115 may communicate with the caller using human-level synthetic speech generated based at least in part on the LLM 124. In box 509, the honeypot call answering service 115 may store the call transcript 160 along with the call metadata 157.

In box 512, the honeypot call answering service 115 trains the caller intent classification ML model 127 based at least in part on the call transcript 160 and the known intent. For example, for a call from a known fraudulent source, the call transcript 160 may be used to train the caller intent classification ML model 127 to recognize call transcripts 160 with similar characteristics as being fraudulent. Conversely, for a call from a known legitimate source, the call transcript 160 may be used to train the caller intent classification ML model 127 to recognize call transcripts 160 with similar characteristics as being legitimate. The call metadata 157 may also be used for training purposes. Thereafter, the operation of the portion of the honeypot call answering service 115 ends.

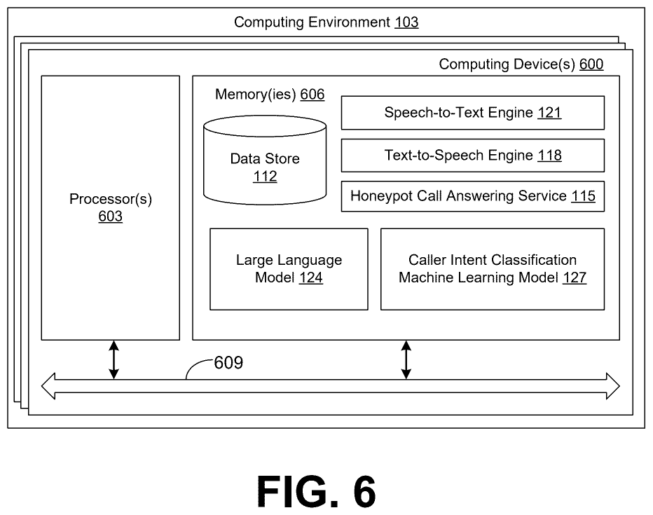

With reference to FIG. 6, shown is a schematic block diagram of the computing environment 103 according to an embodiment of the present disclosure. The computing environment 103 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the speech-to-text engine 121, the text-to-speech engine 118, the honeypot call answering service 115, the LLM 124, the caller intent classification ML model 127, and potentially other applications. Also stored in the memory 606 may be a data store 112 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the speech-to-text engine 121, the text-to-speech engine 118, the honeypot call answering service 115, the LLM 124, the caller intent classification ML model 127, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2-5 show the functionality and operation of an implementation of portions of the honeypot call answering service 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 2-5 show a specific order of execution, it is understood that the order of execution may differ from that which is depicted. For example, the order of execution of two or more blocks may be scrambled relative to the order shown. Also, two or more blocks shown in succession in FIGS. 2-5 may be executed concurrently or with partial concurrence. Further, in some embodiments, one or more of the blocks shown in FIGS. 2-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the speech-to-text engine 121, the text-to-speech engine 118, the honeypot call answering service 115, the LLM 124, and the caller intent classification ML model 127, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the speech-to-text engine 121, the text-to-speech engine 118, the honeypot call answering service 115, the LLM 124, and the caller intent classification ML model 127, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices 600 in the same computing environment 103.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A computer-implemented method, comprising:
answering a call on a honeypot phone number previously used by a customer;
communicating with a caller on the call using human-level synthetic speech generated based at least in part on a language model, the human-level synthetic speech being generated to elicit information from the caller regarding an intent of the caller; and
determining the intent of the caller based at least in part on the information from the caller provided in one or more responses of the caller to the human-level synthetic speech.

2. The computer-implemented method of claim 1, wherein communicating with the caller further comprises:
converting speech of the caller into first text using a speech-to-text engine;
providing the first text to the language model;
receiving second text from the language model; and
generating the human-level synthetic speech from the second text using a text-to-speech engine.

3. The computer-implemented method of claim 1, further comprising ending the call in response to the intent of the caller being determined with at least a threshold confidence level.

4. The computer-implemented method of claim 1, further comprising continuing the call in response to the intent of the caller not being determined with at least a threshold confidence level.

5. The computer-implemented method of claim 1, wherein determining the intent of the caller further comprises using a machine learning model to determine the intent of the caller based at least in part on the information from the caller.

6. The computer-implemented method of claim 5, further comprising training the machine learning model based at least in part on the call originating from a phone number associated with a known intent.

7. The computer-implemented method of claim 1, further comprising storing an association between a phone number originating the call and the intent of the caller.

8. The computer-implemented method of claim 1, further comprising storing metadata about the call.

9. The computer-implemented method of claim 1, further comprising randomly selecting the honeypot phone number to be used as a honeypot from a pool of phone numbers previously used by customers.

10. A system, comprising:
at least one computing device; and
instructions executable by the at least one computing device that cause the at least one computing device to at least:
answer a call on a honeypot phone number previously used by a customer;
communicate with a caller on the call using human-level synthetic speech generated based at least in part on a language model, the human-level synthetic speech being generated to elicit information from the caller regarding an intent of the caller; and
determine the intent of the caller based at least in part on the information from the caller provided in one or more responses of the caller to the human-level synthetic speech.

11. The system of claim 10, wherein the instructions further cause the at least one computing device to at least:
convert speech of the caller into first text using a speech-to-text engine;
provide the first text to the language model;
receive second text from the language model; and
generate the human-level synthetic speech from the second text using a text-to-speech engine.

12. The system of claim 10, wherein the instructions further cause the at least one computing device to at least end the call in response to the intent of the caller being determined with at least a threshold confidence level.

13. The system of claim 10, wherein the instructions further cause the at least one computing device to at least continue the call in response to the intent of the caller not being determined with at least a threshold confidence level.

14. The system of claim 10, wherein the instructions further cause the at least one computing device to at least use a machine learning model to determine the intent of the caller based at least in part on the information from the caller.

15. The system of claim 10, wherein the instructions further cause the at least one computing device to at least train a machine learning model to determine the intent of the caller based at least in part on the call originating from a phone number associated with a known intent.

16. The system of claim 10, wherein the instructions further cause the at least one computing device to at least store an association between a phone number originating the call and the intent of the caller.

17. The system of claim 10, wherein the instructions further cause the at least one computing device to at least randomly select the honeypot phone number to be used as a honeypot from a pool of phone numbers previously used by customers.

18. A non-transitory computer-readable medium storing instructions that when executed cause at least one computing device to at least:
answer a call on a honeypot phone number previously used by a customer;
communicate with a caller on the call using human-level synthetic speech generated based at least in part on a language model, the human-level synthetic speech being generated to elicit information from the caller regarding an intent of the caller; and
determine the intent of the caller based at least in part on the information from the caller provided in one or more responses of the caller to the human-level synthetic speech.

19. The non-transitory computer-readable medium of claim 18, wherein the instructions further cause the at least one computing device to at least end the call in response to the intent of the caller being determined with at least a threshold confidence level.

20. The non-transitory computer-readable medium of claim 18, wherein the instructions further cause the at least one computing device to at least continue the call in response to the intent of the caller not being determined with at least a threshold confidence level.
